(19) United States
(12) Patent Application Publication
(10) Pub. No.: US 2024/0327642 A1
(43) Pub. Date: Oct. 3, 2024

(54) USE OF ASPHALT COMPOSITION FOR WEATHERPROOFING APPLICATION

(71) Applicant: BASF SE, Ludwigshafen am Rhein (DE)

(72) Inventors: Bernie Lewis Malonson, Wyandotte, MI (US); Waldemar Schatz, Lemfoede (DE); Brian Orr, Wyandotte, MI (US)

(73) Assignee: BASF SE, Ludwigshafen am Rhein (DE)

(21) Appl. No.: 18/574,142

(22) PCT Filed: May 9, 2022
(86) PCT No.: PCT/EP2022/062394

§ 371 Date: Dec. 28, 2023

Related U.S. Application Data
(60) Provisional application No. 63/216,011, filed on Jun. 29, 2021.

(30) Foreign Application Priority Data
Sep. 14, 2021 (EP) 21196512.4

(51) Int. Cl. C08L 95/00

(52) U.S. Cl. CPC C08L 95/00; C08L 2555/80

(57) ABSTRACT

The present invention relates to use of an asphalt composition for weatherproofing applications, wherein said composition comprises at least one thermosetting reactive compound, wherein the total amount of thermosetting reactive compounds in the composition is 0.1 to 10.0 wt-% based on the total weight of the composition, and wherein at least one thermosetting reactive compound is an isocyanate.

### FIELD OF INVENTION

The present invention relates to use of an asphalt composition for weatherproofing application.

### BACKGROUND OF THE INVENTION

Apart from its primary use, i.e., road construction, where it is used as the glue or binder mixed with aggregate particles to create concrete, asphalt is also used for producing bituminous waterproofing products, like roofing felt, or sealing materials for flat roofs.

U.S. Pat. No. 2,859,125A outlines an asphalt composition air-blown in the presence of phosphorus pentoxide for use in roofing application, which is capable of being applied on wet surfaces and also cures quickly.

U.S. Pat. No. 6,776,833B2 reveals emulsion for sealants, coatings and/or mastics including a bitumen and a slurry of water and substantially fully hydrated colloidal clay. Said emulsion is noted to improve applicability of end-composition on surfaces such as roofs, by allowing cold application.

However, asphalt compositions, when employable for weatherproofing application, need to possess adequate mechanical strength in addition to weatherability. In particular, roofing applications require special physical properties such as those outlined in ASTM D312. Specifically, suitable compositions must have sufficient resistance to softening, hardness and ductile properties.

US 2019/0177543 A1 pertains to weatherproofing compounds comprising asphalt and polyurethane, wherein the composition has improved mineral adhesion and retention as well as improved weatherability. However, industrial processability of such compositions would require stringent control of viscosity. Furthermore, material cost involved for said compounds (containing 8-20 wt % polyurethanes) is also relatively high.

While the state of art discloses several asphalt compositions, there is an unmet need for asphalt compositions that are particularly suited for use in weatherproofing applications/materials, especially in roofing applications/materials.

It was, therefore, an object of the present invention to provide an asphalt composition that is readily usable for roofing and weatherproofing applications. It was another object of the present invention that the asphalt composition for use in weatherproofing and roofing applications provides suitable physical parameters in accordance with ASTM D312.

### SUMMARY OF THE INVENTION

Surprisingly, it has been found that the above-identified objects are met by providing an asphalt composition as described hereinbelow, wherein said composition comprises at least one thermosetting reactive compound, wherein the total amount of thermosetting reactive compounds in the composition is 0.1 to 10.0 wt.-% based on the total weight of the composition, and wherein at least one thermosetting reactive compound is an isocyanate.

Accordingly, in one aspect, the presently claimed invention is directed to the use of an asphalt composition for weatherproofing applications, wherein said composition comprises at least one thermosetting reactive compound, wherein the total amount of thermosetting reactive compounds in the composition is 0.1 to 10.0 wt.-% based on the total weight of the composition, and wherein at least one thermosetting reactive compound is an isocyanate.

In another aspect, the presently claimed invention is directed to an asphalt composition for use for weatherproofing applications, said composition comprising at least one thermosetting reactive compound, wherein the total amount of thermosetting reactive compounds in the composition is 0.1 to 10.0 wt.-% based on the total weight of the composition and wherein at least one thermosetting reactive compound is an isocyanate.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the features, structures or characteristics may be combined in any suitable manner, as would be apparent to the person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. “a range of 1 to 10” or “in between 1 to 10” implies that both 1 and 10 are included in the range. Additionally, non-integrals values falling within range such as 1.1, 1.2, so on and so forth are also considered to be inclusive. For the avoidance of doubt, the applicant shall be entitled to any equivalents according to applicable law.

An aspect of the present invention is directed towards the use of an asphalt composition for weatherproofing applications, wherein said composition comprises at least one thermosetting reactive compound, wherein the total amount of thermosetting reactive compounds in the composition is 0.1 to 10.0 wt. % based on the total weight of the composition and wherein at least one thermosetting reactive compound is an isocyanate.

Another aspect of the present invention is directed towards an asphalt composition for use in weatherproofing applications, said composition comprising at least one thermosetting reactive compound, wherein the total amount of thermosetting reactive compounds in the composition is 0.1 to 10.0 wt.-% based on the total weight of the composition, and wherein at least one thermosetting reactive compound is an isocyanate.

Preferably, the weatherproofing application is roofing application.

The asphalt composition for use in weatherproofing applications, is preferably reformulated with suitable well-known additives such as fillers, binders, preservatives, pigments among others to form a weatherproofing material. Said material is preferably selected from
paints and coatings, particularly for waterproofing,
mastics for filling joints and sealing cracks,
grouts and hot-poured surfaces for surfacing of roads, aerodromes, sports grounds, etc.,
asphalt emulsion,
hot coatings for surfacing as above,
surface coatings for surfacing,
shingles.

Or any combination of two or more of the aforementioned.

More preferably the weatherproofing material is a shingle for roofing application. Roofing shingles are a roof covering consisting of individual overlapping elements. These elements may be flat, rectangular shapes laid in courses from the bottom edge of the roof up, with each successive course overlapping the joints below.

### Asphalt Composition

According to the invention the asphalt employed in the asphalt composition can be any asphalt known and generally covers any bituminous compound. It can be any of the materials referred to as bitumen or asphalt, for example, distillate, blown, high vacuum, and cut-back bitumen, and also for example asphalt concrete, cast asphalt, asphalt mastic, natural asphalt or mixtures thereof. For example, a directly distilled asphalt may be used, having, for example, a penetration of 80/100 or 180/200. In another embodiment, the asphalt can be free of fly ash.

The different physical properties of the asphalt are measured by different tests known in the art and described in detail in the experimental section. For instance, elastic response and non-recoverable creep compliance (Jnr) are computed in in the Multiple Stress Creep Recovery (MSCR) test in which the asphalt is subjected to a constant load for a fixed time. The total deformation for a specific period of time is given in % and correspond to a measure of the elasticity of the binder. In addition, the phase angle may be measured which illustrates the improved elastic response (reduced phase angles) of the modified binder.

A Bending Beam Rheometer (BBR) is used to determine the stiffness of asphalt at low temperatures and usually refer to flexural stiffness of the asphalt. Two parameters are determined in this test: the creep stiffness is a measure of the resistance of the bitumen to constant loading, and the creep rate (or m value) is a measure of how the asphalt stiffness changes as loads are applied. If the creep stiffness is too high, the asphalt will behave in a brittle manner, and cracking will be more likely. A high m-value is desirable, as the temperature changes and thermal stresses accumulate, the stiffness will change relatively quickly. A high m-value indicates that the asphalt will tend to disperse stresses that would otherwise accumulate to a level where low temperature cracking could occur. Various properties of the asphalt can be determined using standard techniques known to a person skilled in the art. For instance, softening point according to DIN EN1427, rolling Thin Film Oven (RTFO) Test can be determined according to DIN EN 12607-1, dynamic Shear Rheometer (DSR) according to DIN EN 14770-ASTM D7175, multiple Stress Creep Recovery (MSCR) Test according to DIN EN 16659-ASTM D7405, and bending beam rheometer according to DIN EN 14771-ASTM D6648.

According to the invention, the asphalt preferably has a penetration selected from 20-30, 30-45, 35-50, 40-60, 50-70, 70-100, 100-150, 160-220, 250-330,or 300-400, and/or a performance grade selected from 52-16, 52-22, 52-28, 52-34, 52-40, 58-16, 58-22, 58-28, 58-34, 58-40, 64-16, 64-22, 64-28, 64-34, 64-40, 67-22, 70-16, 70-22, 70-28, 70-34, 70-40, 76-16, 76-22, 76-28, 76-34 or 76-40. More Preferably, the penetration is selected from 70-100, 100-150, 160-220, 250-330, or 300-400, and/or the performance grade is selected from 52-16, 52-22, 52-28, 52-34, 52-40, 58-16, 58-22, 58-28, 58-34, 58-40, 64-16, 64-22, 64-28, 64-34, 67-22, 70-16, 70-22, 70-28, 76-16, 76-22, 76-28, 76-34, or 76-40. Even more preferably, the penetration is selected from 100-150, 160-220, 250-330, or 300-400, and/or the performance grade is selected from 52-16, 52-22, 52-28, 52-34, 52-40, 58-16, 58-22, 58-28, 58-34, 64-16, 64-22, 64-28, 67-22, 70-16, 70-22, 76-16, or 76-22. Even more preferably, the penetration is selected from 100-150, 160-220, 250-330, or 300-400, and/or the performance grade is selected from 58-28, 58-34, 64-16, 64-22, 64-28, 67-22, 70-16, 70-22, 76-16, or 76-22. Most preferably, the asphalt has the performance grade selected from 70-16, 70-22, 64-16, 67-22, or 64-22. AASHTO-M320 describes the standard specification for performance graded asphalts, while AASHTO-M20 describes the penetration grade.

Generally, asphalt from different suppliers differ in terms of their composition depending on which reservoir the crude oil is from, as well as the distillation process at the refineries.

However, the cumulated total amount of reactive group is preferably in the range of from 3.1 to 4.5 mg KOH/g. For example, the asphalt having a penetration index of 50-70 or 70-100 results in a stoichiometric amount for pMDI to be 0.8 wt. % to 1.2 wt. %. A further excess of isocyanate will be used to react with the newly formed functionalities due to oxidation sensitivity of the asphalt under elevated temperatures during the preparation of the asphalt composition.

### Thermosetting Reactive Compound

According to the invention, the asphalt composition comprises at least one thermosetting reactive compound, wherein the total amount of thermosetting reactive compounds in the composition is 0.1 to 10.0 wt.-% based on the total weight of the composition and wherein at least one thermosetting reactive compound is an isocyanate.

Generally, by modifying the asphalt using the thermosetting reactive compounds, the performance in terms of different physical properties may be improved for example an increased elastic response can be achieved. The presence of thermosetting reactive compounds in a total amount of 0.1 to 10.0 wt.-% based on the total weight of the composition, wherein at least one thermosetting reactive compound being an isocyanate surprisingly ensures the adherence of the asphalt composition with the standards for roofing application as outlined in ASTM D312.

Without being bound by theory, it is believed that the thermosetting reactive compounds react chemically with different molecular species in the asphalt to generate a specific morphology of colloid structures. In the so obtained asphalt composition, thein physical properties of the asphalt remain more constant over a broad range of temperatures and/or even improve over the temperature range the asphalt composition is subjected to.

In general, the isocyanate(s) can be present in monomeric form, in polymeric form, or as mixture of monomeric and polymeric forms. The term “polymeric” refers to the polymeric grade of the aliphatic, aromatic isocyanate, or mixtures thereof comprising dimers, trimers, higher homologues and/or oligomers.

Preferably the isocyanates amount to 1 to 100 weight % of the thermosetting reactive compounds present in the inventive asphalt composition. More preferably isocyanates amount to 10 to 100 weight % of the thermosetting reactive compounds present in the asphalt composition. Even more preferably, isocyanates amount to 30 to 100 weight % of the thermosetting reactive compounds present in the asphalt composition.

Preferably the isocyanate(s) have a functionality of at least 2.0, or at least 2.3, or at least 2.5, or at least 2.7. More preferably, the isocyanate(s) has a functionality in the range from 2.3 to 4.5, or 2.5 to 4.3, or 2.5 to 4.0.

Preferably the isocyanate(s) are selected from modified and/or unmodified isocyanates.

The unmodified isocyanates are preferably selected from aromatic and/or aliphatic unmodified isocyanates.

Preferably the isocyanate is a modified or unmodified aromatic isocyanate. Aromatic isocyanates include those in which two or more of the isocyanate groups are attached directly and/or indirectly to the aromatic ring. Aromatic isocyantes can be monomeric, polymeric or mixture of monomeric and polymeric forms.

Preferable unmodified aromatic isocyanates are methylene diphenyl diisocyanate (MDI), polymeric MDI, toluene diisocyanate, polymeric toluene diisocyanate, m-phenylene diisocyanate; 1,5-naphthalene diisocyanate; 1,3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate, tolidine diisocyanate, and 1,3,5-triisopropyl benzene-2,4,6-triisocyanate, or combinations of two or more of the aforementioned. In one embodiment, a monomeric mixture (including isomers thereof) and/or polymeric grades of the abovementioned aromatic isocyanates can also be used as thermosetting reactive compounds.

More preferable unmodified aromatic isocyanates are methylene diphenyl diisocyanate (MDI), polymeric MDI, toluene diisocyanate, polymeric toluene diisocyanate, m-phenylene diisocyanate; 1,5-naphthalene diisocyanate; 1,3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; and 3,5,3′,5′-tetraethyl-diphenylmethane-4,4′-diisocyanate, or combinations of two or more of the aforementioned.

Even more preferable unmodified aromatic isocyanates are methylene diphenyl diisocyanate (monomeric MDI), polymeric MDI, toluene diisocyanate, polymeric toluene diisocyanate, m-phenylene diisocyanate; 1,5-naphthalene diisocyanate; 1,3-phenylene diisocyanate; and 2,4,6-toluylene triisocyanate, or combinations of two or more of the aforementioned.

Still more preferable unmodified aromatic isocyanates are monomeric MDI, polymeric MDI, toluene diisocyanate, polymeric toluene diisocyanate, and 1,5-naphthalene diisocyanate, or combinations of two or more of the aforementioned.

Even more preferable unmodified aromatic isocyanates are monomeric MDI and/or polymeric MDI. Monomeric MDI can preferably be selected from 4,4′-MDI, 2,2′-MDI and 2,4′-MDI, or combinations of two or more of the aforementioned.

In an preferred embodiment, the unmodified aromatic isocyanate(s) is polymeric MDI. Preferably, polymeric MDIs may comprise of varying amounts of isomers, for example 4,4′-, 2,2′- and 2,4′-MDI. The amount of 4,4′MDI isomers is from 26 wt. % to 98 wt. %, or from 30 wt. % to 95 wt. %, or from 35 wt. % to 92 wt. %, with respect to the isomers. More preferably, the 2 rings content of the polymeric MDI is from 20% to 62%, or from 26% to 48%, or from 26% to 42%, with respect to the isomers.

Generally, the purity of the polymeric MDI or pMDI is not limited to any value. Preferably, the pMDI used according to the invention has an iron content of from 1 to 100 ppm, or 1 to 70 ppm, or 1 to 80 ppm, or 1 to 60 ppm, based on the total amount of the polymeric MDI.

In a preferred embodiment, the pMDI used according to the invention has a NCO content in the range of from 22 to 40 wt. %, or 25 to 37 wt. %, or 28 to 35 wt. %, or 30 to 33 wt. %, based on total weight of pMDI.

In another preferred embodiment, the pMDI is present of from 0.1 to 10 wt. %, or 0.1 wt. % to 9.5 wt. %, or 0.1 wt. % to 9.0 wt. %, or 0.1 wt. % to 8.5 wt. %, or 0.1 wt. % to 8.0 wt. %, or 0.1 wt. % to 7.5 wt. %, or 0.1 wt. % to 7.0 wt. %, based on the total weight of the asphalt composition.

Preferably, the pMDI has a functionality of at least 2.3, or at least 2.5, or at least 2.7. More preferably, the pMDI has a functionality in the range from 2.3 to 4.5, or 2.5 to 4.3, or 2.5 to 4.0.

Preferably the isocyanate is a modified or unmodified aliphatic isocyanate. Aliphatic isocyanates can be monomeric, polymeric or mixtures of monomeric and polymeric forms.

Preferable unmodified aliphatic isocyanates are cyclobutane-1,3-diisocyanate, 1,2-, 1,3- or 1,4-cyclohexane diisocyanate, 2,4-or 2,6 methylcyclohexane diisocyanate, 4,4′-or 2,4′-dicyclohexyldiisocyanate, 1,3,5-cyclohexane triisocyanate, isocyanatomethylcyclohexane isocyanate, isocyanatoethylcyclohexane isocyanate, bis(isocyanatomethyl) cyclohexane diisocyanate, 4,4′-or 2,4′-bis(isocyanato-methyl) dicyclohexane, isophorone diisocyanate (IPDI), diisocyanatodicyclo-hexylmethane (H12MDI), tetramethylene 1,4-diisocyanate, pentamethylene 1,5-diisocyanate, hexamethylene 1,6-diisocyanate (HDI), decamethylene diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, or combinations of two or more of the aforementioned.

More preferable unmodified aliphatic isocyanates are 2,4-or 2,6 methylcyclohexane diisocyanate, 4,4′-or 2,4′-dicyclohexyldiisocyanate, 1,3,5-cyclohexane triisocyanate, isocyanatomethylcyclohexane isocyanate, isocyanatoethylcyclohexane isocyanate, bis (isocyanatomethyl)cyclohexane diisocyanate, 4,4′-or 2,4′-bis(isocyanato-methyl) dicyclohexane, isophorone diisocyanate (IPDI), diisocyanatodicyclo-hexylmethane (H12MDI), tetramethylene 1,4-diisocyanate, pentamethylene 1,5-diisocyanate, hexamethylene 1,6-diisocyanate (HDI), decamethylene diisocyanate, 1,12-dodecane diisocyanate, 2,2,4-trimethyl-hexamethylene diisocyanate, or a combination of two or more of the aforementioned.

Even more preferable unmodified aliphatic isocyanates are 4,4′-or 2,4′-bis(isocyanato-methyl) dicyclohexane, isophorone diisocyanate (IPDI), diisocyanatodicyclo-hexylmethane (H12MDI), tetramethylene 1,4-diisocyanate, pentamethylene 1,5-diisocyanate, hexamethylene 1,6-diisocyanate (HDI), decamethylene diisocyanate, 1,12-dodecane diisocyanate, and 2,2,4-trimethyl-hexamethylene diisocyanate. Even more preferably, the aliphatic isocyanate is selected from isophorone diisocyanate (IPDI), diisocyanatodicyclo-hexylmethane (H12MDI), hexamethylene 1,6-diisocyanate (HDI), or combinations of two or more of the aforementioned.

In a preferred embodiment, at least one thermosetting reactive compound is an unmodified isocyanate, wherein the total amount of isocyanates amounts to 1 to 100 wt %, or 10 to 99 wt. %, or 30 to 99 wt. %, of the thermosetting reactive compounds present in the asphalt composition.

In another preferred embodiment at least one thermosetting reactive compound is an unmodified aromatic or aliphatic isocyanate, wherein the total amount of isocyanates amounts to 1 to 100 wt %, or 10 to 99 wt. %, or 30 to 99 wt. %, of the thermosetting reactive compounds present in the asphalt composition.

Modified isocyanates, particularly modified monomeric MDIs can be selected from prepolymers, uretonimine and carbodiimide modified as suitable thermosetting reactive compounds.

The modified isocyanates are preferably selected from aromatic and/or aliphatic modified isocyanates.

Preferable modified aromatic isocyanates are carbodiimide modified monomeric MDI, uretonimine modified monomeric MDI, or combinations thereof.

More preferable aromatic isocyanate(s) is carbodiimide modified monomeric MDI.

In a preferred embodiment, the carbodiimide modified monomeric MDI comprises of 65 wt. % to 85 wt. % of 4,4′-MDI and 15 wt. % to 35 wt. % of carbodiimide, said wt. % based on the total weight of the carbodiimide modified monomeric MDI.

In another preferred embodiment, the amount of 4,4′-MDI in the carbodiimide modified monomeric MDI is in the range of from 70 wt. % to 80 wt. % and the amount of carbodiimide is in the range of from 20 wt. % to 30 wt. %.

In another preferred embodiment, the polymeric MDI or pMDI may also comprise modified variants containing carbodiimide, uretonimine, isocyanurate, urethane, allophanate, urea or biuret groups. This all will be referred to in the following as pMDI.

In yet another preferred embodiment, the monomeric MDI has a functionality of at least 2.0, or at least 2.1, or at least 2.15, for example 2.2, 2.3 or 2.4. More preferably, the monomeric MDI has a functionality in the range from 2.3 to 4.5, or 2.5 to 4.3, or 2.5 to 4.0. This all will be referred to in the following as monomeric MDI.

Preferably the isocyanate is a modified aliphatic isocyanate. Modified aliphatic isocyanates are known in the art. Depending on the application, they may be obtainable by well-known methods involving reacting one or more of the above mentioned unmodified aliphatic isocyanate(s) with suitable reactive group(s).

More preferred modified aliphatic isocyanate is a biuret-modified HDI.

In a preferred embodiment, at least one thermosetting reactive compound is a modified isocyanate, wherein the total amount of isocyanates amounts to 1 to 100 wt %, or 10 to 99 wt. %, or 30 to 99 wt. %, of the thermosetting reactive compounds present in the asphalt composition.

In another preferred embodiment at least one thermosetting reactive compound is a modified aromatic or aliphatic isocyanate, wherein the total amount of isocyanates amounts to 1 to 100 wt %, or 10 to 99 wt. %, or 30 to 99 wt. %, of the thermosetting reactive compounds present in the asphalt composition

As mentioned above, the thermosetting reactive compounds are majorly isocyanates. However, it is also possible that optionally thermosetting reactive compounds different from isocyanates are also present in the asphalt composition. Preferably the thermosetting reactive compounds are selected from epoxy resin and/or melamine formaldehyde resin. In such a case, the minimum total amount of isocyanates in the thermosetting reactive compounds is at least 1 wt. %, or 10 wt. %, or 20 wt. %, or 30 wt. % or 40 wt. % or 50 wt. % or 60 wt. % or 70 wt. %, or 80 wt. %, or 85 wt. %, or 88 wt. %, or 90 wt. %, 92 wt. % or 94 wt. % or 96 wt %, or 98 wt. %, 99 wt. %, based on the total weight of the thermosetting reactive compounds present in the asphalt composition. In such cases, the maximum total amount of isocyanates in the thermosetting reactive compounds is at most 99.9 wt. %, or 98 wt. %, or 97 wt. %, or 95 wt. % or 92 wt. % or 90 wt. % or 85 wt. % or 80 wt. %, or 70, based on the total weight of the thermosetting reactive compounds present in the asphalt composition. Preferably, the total amount of isocyantates in the thermosetting reactive compounds ranges of from 1 to 99.9 wt. %, or 10 to 99 wt. %, or 30 to 99 wt. %, based on the total weight of the thermosetting reactive compounds present in the asphalt composition.

Suitable epoxy resins are known in the art and the chemical nature of epoxy resins used according to the present invention is not particularly limited. In a preferred embodiment, the epoxy resins are one or more aromatic epoxy resins and/or cycloaliphatic epoxy resins selected from bisphenol A bisglycidyl ether (DGEBA), bisphenol F bisglycidyl ether, ring-hydrogenated bisphenol A bisglycidyl ether, ring-hydrogenated bisphenol F bisglycidyl ether, bisphenol S bis-glycidyl ether (DGEBS), tetraglycidylmethylenedianiline (TGMDA), epoxy novolaks (the reaction products from epichlorohydrin and phenolic resins (novolak)), cycloaliphatic epoxy resins, such as 3,4-epoxycyclohexylmethyl 3,4-epoxycyclohexanecarboxylate and diglycidyl hexahydrophthalate. Preferably, the epoxy resins can be selected from bisphenol A bisglycidyl ether and/or bisphenol F bisglycidyl ether and mixtures of these two epoxy resins.

Suitable melamine formaldehyde resins are known in the art and are mainly the condensation products of melamine and formaldehyde. Depending on the desired application, they can be modified, for example by reaction with polyvalent alcohols. The chemical nature of melamine formaldehyde resins used according to the invention is not particularly limited. In a preferred embodiment, the melamine formaldehyde resins relate to an aqueous melamine resin mixture with a resin content in the range of from 50 wt. % to 70 wt. %, based on the aqueous melamine resin mixture, with melamine and formaldehyde present in the resin in a molar ratio range of from 1:3 to 1:1, or 1:1.3 to 1:2.0, or 1:1.5 to 1:1.7.

The melamine formaldehyde resin may contain polyvalent alcohols, for example C₂ to C₁₂ diols, in an amount of from 1.0 wt. % to 10.0 wt. %, or 3.0 wt. % to 6.0 wt. %. Suitable C₂ to C₁₂ diols can be selected from diethylene glycol, propylene glycol, butylene glycol, pentane diol and/or hexane diol.

As further additives, the melamine formaldehyde resins may contain 0 wt. % to 8.0 wt. % of caprolactam and 0.5 wt. % to 10 wt. % of 2-(2-phenoxyethoxy)-ethanol and/or polyethylene glycol with an average molecular mass of 200 g/mol to 1500 g/mol, each based on the aqueous melamine resin mixture.

According to the invention, the thermosetting reactive compound is present in an amount of from 0.1 to 10.0 wt. % based on the total weight of the asphalt composition. Preferably, the thermosetting reactive compound is present of from 0.1 wt. % to 9.5 wt. %, or 0.1 wt. % to 9.0 wt. %, or 0.1 wt. % to 8.5 wt. %, or 0.1 wt. % to 8.0 wt. %, or 0.1 wt. % to 7.5 wt. %, or 0.1 wt. % to 7.0 wt. %. In another embodiment, the thermosetting reactive compound in the embodiments 1, 2 or 3 is present of from 0.1 wt. % to 6.5 wt. %, 0.1 wt. % to 6.0 wt. %, or 0.1 wt. % to 5.0 wt. %, or 0.1 wt. % to 5.5 wt. %, or 0.1 wt. % to 4.5 wt. %, or 0.1 wt. % to 4.0 wt. %, or 0.1 wt. % to 3.5 wt. %. In a still another embodiment, it is present of from 0.1 wt. % to 3.0 wt. %, or 0.5 wt. % to 5.0 wt. %, or 0.5 wt. % to 3.0 wt. %, or 1.0 wt. % to 5.0 wt. %, or 1.0 wt. % to 4.5 wt. %, or 1.0 wt. % to 4.0 wt. %, or 1.5 wt. % to 4.0 wt. %, or 1.0 wt. % to 3.0 wt. %.

In a preferred embodiment, the asphalt composition may further comprise a polymer. Suitable polymers according to the invention are selected from styrene/butadiene/styrene copolymer (SBS), styrene butadiene rubber (SBR), neoprene, polyethylene, low density polyethylene, oxidized high density polyethylene, polypropylene, oxidized high density polypropylene, maleated polypropylene, ethylene-butyl-acrylate-glycidyl-methacrylate terpolymer, ethyl vinyl acetate (EVA) and polyphosphoric acid (PPA).

Styrene/butadiene/styrene copolymers (SBS) are known in the art. SBS is a thermoplastic elastomer made with two monomers, which are styrene and butadiene. Therefore, SBS shows the properties of plastic and rubber at the same time. Due to these properties, it is widely used in a variety of areas including the use as asphalt modifying agent and adhesives. SBS-copolymers are based on block copolymers having a rubber centre block and two polystyrene end blocks also named as triblock copolymer A-B-A. SBS elastomers combine the properties of a thermoplastic resin with those of butadiene rubber. The hard, glassy styrene blocks provide mechanical strength and improve the abrasion resistance, while the rubber mid-block provides flexibility and toughness. SBS rubbers are often blended with other polymers to enhance their performance. Often oil and fillers are added to lower cost or to further modify the properties. Various properties of these thermoplastics can be obtained by selecting A and B from a range of molecular weights.

Any of known SBS-copolymers can be used, provided it is compatible with the asphalt composition. Suitable SBS-copolymers are not limited in their structure, they can be branched or linear. Suitable SBS-copolymers are not particularly limited in their styrene content. In one embodiment, the styrene/butadiene/styrene (SBS) copolymers have a styrene content of from 10 wt. % to 50 wt. % based on the total weight of the polymer, or of from 15 wt. % to 45 wt. %, or 20 wt. % to 42 wt. %, or 22 wt. %, or 23 wt. %, or 26 wt. %, or 28 wt. %, or 30 wt. %, or 32 wt. %, or 34 wt. %, or 36 wt. %, or 38 wt. %, or 39 wt. % based on the total weight of the polymer. The term “styrene content” refers to the amount of styrene polymerized into the SBS polymer.

Preferably, the weight average molecular weight (Mw) of the SBS-copolymers is in the range of from 10,000 g/mol to 1,000,000 g/mol, or 30,000 g/mol to 300,000 g/mol, or 70,000 g/mol to 300,000 g/mol, or 75,000 g/mol to 210,000 g/mol, as determined by gel permeation chromatography (GPC).

Suitable styrene-butadiene or styrene-butadiene rubber (SBR) are known in the art and described as families of synthetic rubbers derived from styrene and butadiene. The styrene/butadiene ratio influences the properties of the polymer: with high styrene content, the rubbers are harder and less rubbery. Generally, any of known SBR-copolymers can be used, provided it is compatible with the asphalt composition. Suitable SBR-copolymers are not limited in their structure, they can be branched or linear. Suitable SBR-copolymers are not particularly limited in their styrene content. In one embodiment, the SBR copolymers have a styrene content of from 10 wt. % to 50 wt. % based on the total weight of the polymer, or 15 wt. % to 45 wt. %, or 20 wt. % to 42 wt. %, or 22 wt. %, or 23 wt. %, or 26 wt. %, or 28 wt. %, or 30 wt. %, or 32 wt. %, or 34 wt. %, or 36 wt. %, or 38 wt. %, or 39 wt. % based on the total weight of the polymer.

Preferably, the weight average molecular weight (Mw) of the SBR-copolymers is in the range of from 10,000 g/mol to 500,000 g/mol, or 50,000 g/mol to 250,000 g/mol, or 70,000 g/mol to 150,000 g/mol, or 75,000 g/mol to 135,000 g/mol, as determined by gel permeation chromatography (GPC).

Generally, neoprene is known in the art and is the generic name for polymers synthesized from chloroprene. It is often supplied in latex form. It may be a colloidal dispersion of chloroprene polymers prepared by emulsion polymerization. The neoprene structure is extremely regular although its tendency to crystallize can be controlled by altering the polymerization temperature. The final polymer is comprised of a linear sequence of trans-3-chloro-2-butylene units which are derived from the trans 1,4 addition polymerization of chloroprene.

While any of the known neoprene can be used, provided it is compatible with the asphalt. In one embodiment, a neoprene latex is used. Suitable neoprene latex has a solid content of from 30 wt. % to 60 wt. % based on the total weight of the latex, or of from 30 wt. % to 60 wt. %, or of from 30 wt. % to 60 wt. %.

Suitable polyethylene and polypropylene homopolymers or copolymers as well as modified polyethylene and polypropylene polymers, for example low density polyethylene, oxidized high density polypropylene, maleated polypropylene are known in the art and described as families of polymers/copolymers based on the respective monomers. The molecular weight and the degree of crystallinity greatly influences the properties of these polymers. Polyethylene and polypropylene homopolymers or copolymers as well as modified polyethylene and polypropylene polymers with high levels of structuring show high tensile strengths but little ability to deform before failure. Less structuring results in an increased ability of the material to flow. For example, polyethylenes, as is typical of paraffinic materials, are also relatively unreactive with most solvents. In addition to the molecular weight and the degree of crystallinity also the density has a large influence on the properties of the respective polymer since the lower densities represent less molecular packing, and hence less structuring. Low and high density polyethylenes are generally defined as those having a specific gravity of about 0.915 to 0.94 and approximately 0.96, respectively, determined according to ASTM D792. Also, modifiers incorporated as copolymers are used to disrupt the crystalline nature of the unmodified polymers for example polyethylene and this results in a more elastic, amorphous additive. The function of these polymers within the asphalt composition is not to form a network but to provide plastic inclusions within the matrix. At cold temperatures, these inclusions are intended to directly improve the binder's resistance to thermal cracking by inhibiting the propagation of cracks. At warm temperatures, the particle inclusions should increase the viscosity of the binder and therefore the mixture's resistance to rutting.

Any of known polyethylene and polypropylene homopolymers or copolymers as well as modified polyethylene and polypropylene polymers can be used in the asphalt composition, provided it is compatible with the asphalt. Suitable polymers like polyethylene, low density polyethylene, oxidized high density polyethylene, polypropylene, oxidized high density polypropylene, maleated polypropylene, are not particularly limited in their molecular weight. Preferably, each of the polyethylene, low density polyethylene, oxidized high density polyethylene, polypropylene, oxidized high density polypropylene, maleated polypropylene, has a weight average molecular weight (Mw) ranging of from 800 g/mol to 50,000 g/mol, or 1000 g/mol to 45,000 g/mol, or 2000 g/mol to 42,000 g/mol, or 1,000 g/mol to 5,000 g/mol, or 5,000 g/mol to about 10,000 g/mol, or 10,000 g/mol to 20,000g/mol, or 20,000 g/mol to 30,000 g/mol, or 30,000 g/mol to 40,000 g/mol, or 40,000 g/mol to about 50,000 g/mol, as determined by gel permeation chromatography (GPC). Such polymers may be used as plastomers into the asphalt composition.

Furthermore, suitable polymers like polyethylene, low density polyethylene, oxidized high density polyethylene, polypropylene, oxidized high density polypropylene, maleated polypropylene are not particularly limited in their crystallinity. In an embodiment, each of the polyethylene, low density polyethylene, oxidized high density polyethylene, polypropylene, oxidized high density polypropylene, maleated polypropylene has a crystallinity of greater than 50%, based on the total weight of the polymer being described, or in the range of from 52% to 99%, or 55% to 90%. The crystallinity of the aforesaid polymers is determined by Differential Scanning calorimetry (DSC), which is a technique generally known in the art.

Also, complex polyethylene copolymers are known in the art as for example ethylene-butyl-acrylate-glycidyl-methacrylate terpolymer based on three different monomers. This family of copolymers is known as plasticizer resins which are improving flexibility and toughness. For example, these copolymers are commercially available from DuPont, under the name Elvaloy® terpolymers.

Any of known ethylene-butyl-acrylate-glycidyl-methacrylate terpolymer can be used in the asphalt composition, provided it is compatible with the asphalt. Suitable polymers like ethylene-butyl-acrylate-glycidyl-methacrylate terpolymer are not particularly limited in their molecular weight. Preferably, the ethylene-butyl-acrylate-glycidyl-methacrylate terpolymer has a weight average molecular weight (Mw) of from 800 g/mol to 150,000 g/mol, or 1500 g/mol to 120,000 g/mol, or 5000 g/mol to 90,000 g/mol, as determined by gel permeation chromatography (GPC).

Suitable ethylene and vinyl acetate copolymers (EVA) are known in the art and described as families of copolymers based on the respective monomers. The inclusion of the vinyl acetate is used to decrease the crystallinity of the ethylene structure and to help make the plastomers more compatible with the asphalt composition. Copolymers with 30 percent vinyl acetate are classified as flexible, resins that are soluble in toluene and benzene. When the vinyl acetate percentage is increased to 45 percent, the resulting product is rubbery and may be vulcanized.

While any of the known EVA-copolymers can be used, provided it is compatible with the asphalt composition. Suitable EVA-copolymers are not limited in their structure, they can be branched or linear, preferably the EVA-copolymers are linear. Suitable EVA-copolymers are not particularly limited in their vinyl acetate content. Preferably, the EVA copolymers have a vinyl acetate content of from 20 wt. % to 60 wt. % based on the total weight of the polymer, or 25 wt. % to 50 wt. %, or 30 wt. % to 45 wt. %.

Generally, polyphosphoric acid (PPA) is known in the art and is a polymer of orthophosphoric acid (H₃PO₄) of the general formula (Hₙ₊₂PₙO₃ₙ₊₁). Polyphosphoric acid is a mixture of orthophosphoric acid with pyrophosphoric acid, triphosphoric and higher acids and is often characterized on the basis of its calculated content of H₃PO₄. Superphosphoric acid is a similar mixture differentiating in the content of H₃PO₄ and can be subsumed under the definition of PPA in the context of this invention. Generally, any of the known Polyphosphoric acids can be used, provided it is compatible with the asphalt. Suitable Polyphosphoric acids according to the invention are not limited in their structure and composition of orthophosphoric acid with pyrophosphoric acid, triphosphoric and higher acids, preferably the PPA is water-free. In one embodiment, the polyphosphoric acid (PPA) has a calculated H₃PO₄ content of from 100% to 120%, or 103% to 118%, or 104% to 117%.

The polyphosphoric acid may be used as an additional additive of the asphalt composition, in conventional amount, for example to raise the product's softening point. The phosphoric acid may be provided in any suitable form, including a mixture of different forms of phosphoric acid. For example, some suitable different forms of phosphoric acid include phosphoric acid, polyphosphoric acid, super phosphoric acid, pyrophosphoric acid and triphosphoric acid.

Further optional additives known in the art may be added to the asphalt composition according to the invention in order to adapt the properties of the asphalt composition depending on the respective application. Additives may be for example waxes. These waxes if used as an additional additive in the asphalt binder composition may be functionalized or synthetic waxes, or naturally occurring waxes. Furthermore, the wax may be oxidized or non-oxidized. Non-exclusive examples of synthetic waxes included ethylene bis-stearamide was (EBS), Fischer-Tropsch wax (FT), oxidized Fischer-Tropsch wax (FTO), polyolefin waxes such as polyethylene wax (PE), oxidized polyethylene wax (OxPE), polypropylene wax, polypropylene/polyethylene wax alcohol wax, silicone wax, petroleum waxes such as microcrystalline wax or paraffin, and other synthetic waxes. Non-exclusive examples of functionalized waxes include amine waxes, amide waxes, ester waxes, carboxylic acid waxes, and microcrystalline waxes. Naturally occurring waxes may be derived from a plant, from an animal, or from a mineral, or from other sources. Non-exclusive examples of natural waxes include plant waxes such as candelilla wax, carnauba wax, rice wax, Japan wax and jojoba oil; animal waxes such as beeswax, lanolin and whale wax; and mineral waxes such as montan wax, ozokerit and ceresin.

Mixtures of the aforesaid waxes are also suitable, such as, for example, the wax may include a blend of a Fischer-Tropsch (FT) wax and a polyethylene wax.

Plasticizers may also be used as additional additives, in conventional amounts, to increase the plasticity or fluidity of the asphalt composition. Suitable plasticizers include hydrocarbon oils (e.g. paraffin, aromatic and naphthenic oils), long chain carbon diesters (e.g. phthalic acid esters, such as dioctyl phthalate, and adipic acid esters, such as dioctyl adipate), sebacic acid esters, glycol, fatty acid, phosphoric and stearic esters, epoxy plasticizers (e.g. epoxidized soybean oil), polyether and polyester plasticizers, alkyl monoesters (e.g. butyl oleate), long chain partial ether esters (e.g. butyl cellosolve oleate) among other plasticizers.

Antioxidants may be used in conventional amounts as additional additives for the asphalt binder compositions to prevent the oxidative degradation of polymers that causes a loss of strength and flexibility in these materials.

Conventional amounts with regard to the optional additives are in the range of from 0.1 wt. % to 5.0 wt. % based on the total amount of the asphalt composition.

Various parameters are important to identify suitability towards specific applications such as weatherproofing application. The properties of the asphalt composition such as an increased useful temperature interval, an increased elastic response, a good adhesion and an increased load rating as well as a reduced potential for permanent asphalt deformations, may depend on the particle concentration with a specific sedimentation coefficient, which is directly correlated to the particle size, of the corresponding composition. According to the invention, the asphalt composition has at least 18% by weight based on the total weight of the composition particles with a sedimentation coefficient above 5000 Sved in a white spirit solvent.

Preferably, the asphalt composition has at least 20% by weight, or at least 23% by weight based on the total weight of the composition particles with a sedimentation coefficient above 5000 Sved in a white spirit solvent. These particles with a sedimentation coefficient above 5000 Sved in a white spirit solvent can be up to 99.9% by weight based on the total weight of the composition, or less than 95% by weight, or less than 90% by weight, or less than 80% by weight based on the total weight of the composition. For example, 18% to 75% by weight based on the total weight of the composition particles with a sedimentation coefficient in the range of from 15000 to 170000 Sved in a white spirit solvent, or 23% to 65% by weight based on the total weight of the composition particles with a sedimentation coefficient in the range of from 25000 to 140000 Sved in a white spirit solvent, or 30% to 52% by weight based on the total weight of the composition particles with a sedimentation coefficient in the range of from 22000 to 95000 Sved in a white spirit solvent.

In the present context, white spirit solvent refers to white spirit high-boiling petroleum with the CAS-Nr.: 64742-82-1, having 18% aromatics basis and a boiling point of from 180° C. to 220° C. The sedimentation coefficient can be detected by ultracentrifugation combined to absorption optical devices. The sedimentation and concentration of each component are measured with a wavelength of 350 nm. An exemplary measurement technique for determining the particles in the asphalt composition is described hereinbelow.

The determination of particles in the asphalt composition is carried out by fractionation experiments using analytical ultracentrifugation. Sedimentation velocity runs using a Beckman Optima XL-I (Beckman Instruments, Palo Alto, USA) can be performed. The integrated scanning UV/VIS absorbance optical system is used. A wavelength of 350 nm is chosen, with the samples measured at a concentration of about 0.2g/l after dilution in a white spirit solvent (CAS-Nr.: 64742-82-1). In order to detect the soluble and insoluble parts, centrifugation speed is varied from 1000 rpm to 55,000 rpm. The distribution of sedimentation coefficients, defined as the weight fraction of species with a sedimentation coefficient between s and s +ds, and the concentration of one sedimenting fraction are determined using a standard analysis Software (for e.g. SEDFIT). The change of the whole radial concentration profile with time is recorded and converted in distributions of sedimentation coefficient g(s). The sedimentation coefficient is in units of Sved (1Sved=10-13 seconds). The particles in the asphalt composition are determined by quantifying the light absorption of the fast and slow sedimenting fractions at the used wavelength.

The presently claimed invention is illustrated in more detail by the following embodiments and combinations of embodiments which results from the corresponding dependency references and links:
I. Use of an asphalt composition for weatherproofing application, wherein said composition comprises thermosetting compounds in a total amount of 0.1 to 10.0 wt.-% based on the total weight of the composition, wherein at least one thermosetting reactive compound is an isocyanate.
II. The use according to embodiment I, wherein the weatherproofing application comprises roofing application.
III. The use according to embodiment I or II, wherein the thermosetting reactive compound is present in an amount of from 1.0 wt. % to 5.0 wt. %, based on the total weight of the asphalt composition.
IV. The use according to any of the preceding embodiments, wherein the isocyanate is selected from aromatic isocyanates or aliphatic isocyanates.
V. The use according to embodiment IV, wherein the aromatic isocyanate is selected from monomeric MDI, polymeric MDI, toluene diisocyanate, polymeric toluene diisocyanate, or 1,5-naphthalene diisocyanate.
VI. The use according to embodiment IV or V, wherein the aromatic isocyanate is monomeric MDI and/or polymeric MDI.
VII. The use according to embodiment V or VI, wherein the polymeric MDI has a functionality of at least 2.5.
VIII. The use according to embodiment V to VII, wherein the polymeric MDI has a functionality in the range from 2.5 to 4.
IX. The use according to any of the preceding embodiments, wherein the amount of polymeric MDI is of from 0.5 to 2.0 wt. % based on the total weight of the composition.
X. The use according to any of embodiments V to VIII, wherein the amount of polymeric MDI is of from 2.0 to 5.0 wt. % based on the total weight of the composition.
XI. The use according to any of embodiments V to X, wherein the polymeric MDI has an iron content in the range of from 1 to 100 ppm.
XII. The use according to any of embodiments V to XI, wherein the polymeric MDI has an iron content in the range of from 1 to 80 ppm.
XIII. The use according to embodiment VI, wherein the monomeric MDI is a carbodiimide modified monomeric MDI.
XIV. The use according to embodiment XIII, wherein the carbodiimide modified monomeric MDI comprises 65 wt. % to 85 wt. % of 4,4′-MDI and 15 wt. % to 35 wt. % of carbodiimide, said wt. % based on the total weight of the carbodiimide modified monomeric MDI.
XV. The use according to any of the preceding embodiments, wherein the asphalt composition further comprises a polymer selected from styrene/butadiene/styrene copolymer (SBS), styrene butadiene rubber (SBR), neoprene, polyethylene, low density polyethylene, oxidized high density polyethylene, polypropylene, oxidized high density polypropylene, maleated polypropylene, ethylene-butyl-acrylate-glycidyl-methacrylate terpolymer, ethyl vinyl acetate (EVA), or polyphosphoric acid (PPA).
XVI. The use according to any of the preceding embodiments, wherein the thermosetting reactive compound further comprises epoxy resin and/or melamine formaldehyde resin.
XVII. The use according to any of the preceding embodiments, wherein at least 18% by weight based on the total weight of the composition are particles with a sedimentation coefficient above 5000 Sved in a white spirit solvent.
XVIII. The use according to any of the preceding embodiments, wherein at least 20% by weight based on the total weight of the composition are particles with a sedimentation coefficient in a range of from 10000 to 1000000 Sved in a white spirit solvent.
XIX. An asphalt composition for use in weatherproofing application, said composition comprising thermosetting compounds in a total amount of 0.1 to 10.0 wt.-% based on the total weight of the composition, wherein at least one thermosetting reactive compound comprises an isocyanate.
XX. The asphalt composition of embodiment XIX, wherein weatherproofing application comprises roofing application.

### EXAMPLES

The presently claimed invention is illustrated by the non-restrictive examples which are as follows:

### Raw Materials

ASPHALT (SA)

| | |
|---|---|
| SA | Asphalt having performance grade of 70/100 |
| | and 30/45 according to AASHTO - M320 |

THERMOSETTING REACTIVE COMPOUND (TRC)

| | |
|---|---|
| TRC | Polymeric MDI with a functionality of |
| | 2.7 and NCO content ranging between 30 |
| | wt. % to 33 wt. %, obtained from BASF |

### Asphalt Tests

Softening point—ASTM D36/D36M-14(2020)
Needle penetration at 77° F.—ASTM D5/D5M-20
Ductile properties—ASTM D113-17 and AASHTO T300

### General Synthesis of Inventive Asphalt Composition (IE)

The asphalt (SA) was heated up to 150° C. under oxygen atmosphere and stirred at 400 rpm in a heating mantle (temperature set up to 150° C.). Thereafter, 2.0 wt. % of thermosetting reactive compound (TRC) was added. The reaction was further stirred at 150° C. for 2-4 h. The completion of reaction can be followed by infrared spectroscopy, specifically, the isocyanate peak at 2270 cm⁻¹. Disappearance of peak indicates reaction completion and the reaction mixture is subsequently allowed to cool down to room temperature.

The comparative asphalt (C1) was also prepared (with percentages as per table 1 below) similarly, however TRC was not added.

TABLE 1
Composition details:

| | Inventive composition | Comparative |
|---|---|---|
| Component | (wt %) | composition |
| Asphalt (SA1) | 98 | 100 |
| TRC | 2 | — |

In accordance with the requirements outlined in ASTM D312, the inventive as well as comparative composition (without TRC), were evaluated on three parameters (as mentioned in table 2 below) to establish their suitability towards weatherproofing applications, in particular roofing applications. Here, evaluation was carried out with two sets of compositions having different binder penetration grades, namely 30/45 and 70/100. 70/100 penetration grade is the softer material.

TABLE 2
Physical evaluation of inventive and
comparative asphalt composition

| | Binder Penetration Grade 30/45 | | |
|---|---|---|---|
| | ASTM/AASHTO | Comparative | Inventive |
| | method | composition | composition |
| Softening point ° C. | D36 | 51.8 | 66 |
| Needle Penetration | D5 | 42 | 20 |
| at 77° F. | | | |
| Force-Ductility in N | T300 | 6.7 | 22 |
| | Binder Penetration Grade 70/100 | | |
| | ASTM/AASHTO | Comparative | Inventive |
| | method | composition | composition |
| Softening point ° C. | D36 | 47 | 57 |
| Needle Penetration | D5 | 77 | 39 |
| at 77° F. | | | |
| Force-Ductility in N | T300 | 1.8 | 6.3 |

From above table it is evident that the resistance to softening is increased, for instance the grade 30/45 composition is noted to show an increase in softening point from 51.8° C. to 66° C. Similarly, the overall hardness and consistency of the composition is remarkably improved with the needle penetration at 77° F. decreasing sharply for the inventive compositions (comprising TRC). Also, especially important for roofing application, is the modulation of physical properties, such that the ductility is reduced but the overall toughness is increased. This is evident from the surprising increase in force ductility from 6.7 N for comparative composition to 22 N for inventive composition (grade 30/45 composition). As evident above, the presence of thermosetting reactive compound or TRC in inventive asphalt compositions considerably improves mentioned properties, making them especially suited for weatherproofing and roofing applications (in accordance with ASTM D312).

1.-19. (canceled)

20. A method comprising providing an asphalt composition for weatherproofing applications, wherein said composition comprises at least one thermosetting reactive compound, wherein the total amount of thermosetting reactive compounds in the composition is 0.1 to 10.0 wt.-% based on the total weight of the composition, and wherein at least one thermosetting reactive compound is an isocyanate.

21. The method according to claim 20, wherein the weatherproofing applications are roofing applications.

22. The method according to claim 20, wherein the thermosetting reactive compounds are present in a total amount of from 1.0 wt. % to 5.0 wt. %, based on the total weight of the asphalt composition.

23. The method according to claim 20, wherein the isocyanate is selected from aromatic isocyanates or aliphatic isocyanates.

24. The method according to claim 23, wherein the aromatic isocyanate is selected from monomeric MDI, polymeric MDI, toluene diisocyanate, polymeric toluene diisocyanate, or 1,5-naphthalene diisocyanate.

25. The method according to claim 23, wherein the aromatic isocyanate is monomeric MDI and/or polymeric MDI.

26. The method according to claim 24, wherein the polymeric MDI has a functionality of at least 2.5.

27. The method according to claim 24, wherein the polymeric MDI has a functionality in the range 2.5 to 4.

28. The method according to claim 20, wherein the amount of polymeric MDI is of from 0.5 to 2.0 wt. % based on the total weight of the composition.

29. The method according to claim 24, wherein the amount of polymeric MDI is of from 2.0 to 5.0 wt. % based on the total weight of the composition.

30. The method according to claim 24, wherein the polymeric MDI has an iron content in the range of from 1 to 100 ppm by weight.

31. The method according to claim 25, wherein the monomeric MDI is a carbodiimide modified monomeric MDI.

32. The method according to claim 31, wherein the carbodiimide modified monomeric MDI comprises 65 wt. % to 85 wt. % of 4,4′-MDI and 15 wt. % to 35 wt. % of carbodiimide, said wt. % based on the total weight of the carbodiimide modified monomeric MDI.

33. The method according to claim 20, wherein the asphalt composition further comprises at least one polymer selected from styrene/butadiene/styrene copolymer (SBS), styrene butadiene rubber (SBR), neoprene, polyethylene, low density polyethylene, oxidized high density polyethylene, polypropylene, oxidized high density polypropylene, maleated polypropylene, ethylene-butyl-acrylate-glycidyl-methacrylate terpolymer, ethyl vinyl acetate (EVA), polyphosphoric acid (PPA), or a combination of two or more of the aforementioned.

34. The method according to claim 20, wherein the thermosetting reactive compound further comprises at least one epoxy resin and/or at least melamine formaldehyde resin.

35. The method according to claim 20, wherein at least 18% by weight based on the total weight of the composition are particles with a sedimentation coefficient above 5000 Sved in a white spirit solvent.

36. The method according to claim 20, wherein at least 20% by weight based on the total weight of the composition are particles with a sedimentation coefficient in a range of from 10000 to 1000000 Sved in a white spirit solvent.

37. An asphalt composition for weatherproofing applications, wherein said composition comprises at least one thermosetting reactive compound, wherein the total amount of thermosetting reactive compounds in the composition is 0.1 to 10.0 wt.-% based on the total weight of the composition, and wherein at least one thermosetting reactive compound is an isocyanate.

38. The asphalt composition of claim 37, wherein weatherproofing applications are roofing application.
